(19) United States
(12) Patent Application Publication
(10) Pub. No.: US 2026/0329568 A1
(43) Pub. Date: Oct. 22, 2026

(54) MODIFICATION OF CONTAINER IMAGE OF AN APPLICATION USING DEPENDENCY GRAPH

(71) Applicant: International Business Machines Corporation, Armonk, NY (US)

(72) Inventors: Rossella De Gaetano, Rome (IT); Davide Fazzone, Rome (IT); Luigi Lombardi, Napoli (IT); Michele Crudele, Roma (IT)

(21) Appl. No.: 19/182,110

(22) Filed: Apr. 17, 2025

(51) Int. Cl. G06F 8/61; G06F 8/41

(52) U.S. Cl. CPC G06F 8/63; G06F 8/433

(57) ABSTRACT

Modification of container image of an application using a dependency graph is provided and includes retrieving the container image that includes a set of layers associated with the application. A modified first layer is determined based on a first hash-based identifier of a set of entities associated with a first layer of the set of layers. A presence of a first dependency relationship between the first layer and at least a second layer of the set of layers is determined based on the dependency graph. The dependency graph is indicative of a plurality of dependency relationships between the set of layers. The at least second layer is modified based on the determination of the presence of the first dependency relationship. Based on the modified first layer and the modified at least second layer, the container image is modified, and the modified container image is outputted.

### BACKGROUND

The disclosure relates to containerization and more particularly, to container image.

In recent years, there has been a notable shift from traditional monolithic applications, which typically operate on virtual or physical servers, to microservices architectures that leverage containers. This evolution is driven by the need for enhanced flexibility, scalability, and efficiency in software development processes. Containerization technologies, such as Docker®, have become critical tools in this transformation, enabling developers to package applications and their dependencies into isolated environments known as container images.

A container image is a lightweight, standalone, and executable package that includes everything needed to run a piece of software, including the application code, runtime, libraries, environment variables, and configuration files. Container images are revolutionizing the way software is written, deployed, and operated. As a result, organizations can deploy new features and fixes more rapidly, significantly improving their time-to-market. The application of containerization technologies extends beyond mere software development; the containerization technologies also enhance operational efficiency and resource utilization. By encapsulating applications in containers, organizations can achieve greater consistency across different environments, from development to production.

This consistency reduces the likelihood of environment-related issues and simplifies the deployment process. Additionally, containers can be easily orchestrated and scaled, allowing organizations to respond dynamically to changing workloads and demands. Overall, the adoption of containerization technologies represents a significant advancement in the way software is developed and deployed, offering numerous advantages in terms of efficiency, scalability, and operational agility.

### SUMMARY

In various embodiments of the disclosure, a computer-implemented method for modification of a container image of an application using a dependency graph is described. The computer-implemented method includes retrieving, by a computer, the container image including a set of layers. The container image is associated with the applications. The computer-implemented method further includes determining, by the computer, a first layer of the set of layers is modified. The determination is based on a first hash-based identifier of a set of entities associated with the first layer. The computer-implemented method further includes determining, by the computer, a presence of a first dependency relationship between the first layer and at least a second layer of the set of layers based on the dependency graph. The dependency graph is indicative of a plurality of dependency relationships between the set of layers. The plurality of dependency relationships is inclusive of the first dependency relationship. The computer-implemented method further includes modifying, by the computer, the at least second layer based on the determination of the presence of the first dependency relationship. The computer-implemented method further includes modifying, by the computer, the container image based on the modified first layer and the modified at least second layer. The computer-implemented method further includes outputting, by the computer, the modified container image. It is to be noted that a person with ordinary skill in the art will understand that the first layer and the at least second layer might not need to be consecutive layers, the first layer and the at least second layer can be any layers from the set of layers that are dependent on each other. For example, “layer 1” can be the first layer and “layer 5” can be the second layer.

In various embodiments of the disclosure, a computer-program product for modification of a container image of an application using a dependency graph is described. The computer program product includes one or more computer-readable storage media and program instructions stored in the one or more computer-readable storage media to perform operations that include retrieving the container image including a set of layers. The container image is associated with the application. The operations further include determining a first layer of the set of layers is modified. The determination is based on a first hash-based identifier of a set of entities associated with the first layer. The operations further include determining an absence of a first dependency relationship between the first layer and at least a second layer of the set of layers based on a dependency graph. The dependency graph is indicative of a plurality of dependency relationships between the set of layers. The plurality of dependency relationships is exclusive of the first dependency relationship. The operations further include modifying the container image using the modified first layer based on the determination of the absence of the first dependency relationship. The operations further include outputting the modified container image. It is to be noted that a person with ordinary skill in the art will understand that the first layer and the at least second layer might not need to be consecutive layers, the first layer and the at least second layer can be any layers from the set of layers. For example, “layer 1” can be the first layer and “layer 5” can be the second layer.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF DRAWINGS

The following description will provide details of preferred embodiments with reference to the following figures, wherein:

FIG. 1 is a diagram that illustrates a computing environment for modification of container image of an application using a dependency graph, in accordance with an embodiment of the disclosure;

FIG. 2A is a diagram that illustrates an environment for modification of a container image of an application using a dependency graph, in accordance with an embodiment of the disclosure;

FIG. 2B is a diagram that illustrates an exemplary layered architecture of a container image of an application, in accordance with an embodiment of the disclosure;

FIG. 3A is a diagram that illustrates exemplary operations for generation of a dependency graph for modification of a container image of an application, in accordance with an embodiment of the disclosure;

FIG. 3B is a diagram that illustrates an exemplary scenario for modification of a container image of an application, in accordance with an embodiment of the disclosure;

FIG. 4A is a diagram that illustrates first exemplary operations for modification of a dependency graph for modification of a container image of an application, in accordance with an embodiment of the disclosure;

FIG. 4B is a diagram that illustrates exemplary operations for modification of a dependency graph for modification of a container image of an application, in accordance with an embodiment of the disclosure;

FIG. 5 is a diagram that illustrates exemplary operations for modification of a container image of an application using a dependency graph, in accordance with an embodiment of the disclosure;

FIG. 6A is a diagram that illustrates an exemplary first user interface for modification of a container image of an application using a dependency graph, in accordance with an embodiment of the disclosure;

FIG. 6B is a diagram that illustrates an exemplary second user interface for modification of a container image of an application using a dependency graph, in accordance with an embodiment of the disclosure;

FIG. 7 is a diagram that illustrates a flowchart of a first exemplary method for modification of a container image of an application using a dependency graph, in accordance with an embodiment of the disclosure; and

FIG. 8 is a diagram that illustrates a flowchart of a second exemplary method for modification of a container image of an application using a dependency graph, in accordance with an embodiment of the disclosure.

### DETAILED DESCRIPTION

The field of containerization and microservices architecture has become increasingly prominent in modern IT infrastructures, marking a significant shift from traditional monolithic applications. This trend is driven by the need for greater agility, scalability, and efficiency in software development and deployment. Containerization technologies, such as Docker®, have become critical tools in this transformation, enabling developers to package applications and their dependencies into isolated environments known as container images. A container image is a lightweight, standalone, and executable package that includes everything needed to run a piece of software, including the application code, runtime, libraries, environment variables, and configuration files.

The container image is a combination of multiple layers that store the application code, runtime, libraries, environment variables, and configuration files. These container images have a wide range of applications across various sectors, particularly in software development and deployment. In development, the container images allow teams to create consistent environments that mirror production settings, reducing the risk of discrepancies and ensuring that applications function as intended. Such consistency accelerates the development lifecycle, enabling faster iterations and more reliable releases. Additionally, the container images facilitate continuous integration and delivery (CI/CD) practices, allowing organizations to automate testing and deployment processes, thereby improving overall efficiency.

In the field of cloud computing, container images enable organizations to manage resource utilization and scale applications dynamically. By deploying containerized applications in cloud environments, businesses can take advantage of on-demand resources, reducing operational costs and enhancing performance.

Despite the advantages of container images, several challenges persist in the current scenario of utilization of these container images. One significant issue is the complexity involved in managing these container images. When a change is identified in the accessed files and folders of a specific layer of the multiple layers of the container image, the entire container image must be rebuilt, retested, and redeployed, which can be a time-consuming process. This complexity can further lead to delays in deploying critical updates, potentially exposing organizations to security risks. Further, rebuilding and redeploying all the layers of the container image is a time-consuming and resource intensive process. Therefore, there is a need of an innovative solution to generation of container images in order to remove this limitation of rebuilding and redeploying most of the layers of the container image even when a single layer is changed or modified.

Traditional methods of modification of container images rely on rebuilding, retesting, and redeploying the entire container image of the application which can be a time-consuming process. Furthermore, most traditional methods are majorly focused on rebuilding, retesting, and redeploying each layer above the specific layer (vulnerable layer or the changed (modified) layer) of the container image which is still a time-consuming task.

Such traditional methods increase the processing time of the computing system and the computing resources for the modification of the container images since the traditional methods need rebuilding, retesting, and redeploying most of the layers of the container image, even when a single layer of the container image is modified. The traditional methods further rely on parsing the files and folders accessed by the layers of the container images to determine whether the container images need to be rebuilt which further increases the processing time of the computing system and the computing resources. Therefore, there is a need for an improved approach to the modification of container images to eliminate the problems associated with the traditional methods.

The disclosed system performs modification of the container images by rebuilding only dependent layers of the changed (modified) layer of the container image. The dependent layers refer to those layers of the container image that access the common files and folders as the layer that has been changed or modified. The disclosed system utilizes a dependency graph for identifying the dependent layers of the layer that has been modified. Therefore, the disclosed system reduces the processing time of the computing system and the computing resources for the modification of the container images since it eliminates the need for rebuilding the entire container image.

The disclosed system further generates and utilizes hash-values and checksum values of the files and folders accessed by the layers of the container image to determine whether the layers of the container image need to be rebuilt. The utilization of the hash-values and the checksum values (instead of parsing the entire files and the folders) also reduces the processing time for the determination of the layers of the container image that need to be rebuilt.

In various embodiments of the disclosure, a computer-implemented method for modification of container image of an application using a dependency graph is described. The computer-implemented method includes retrieving, by a computer, the container image including a set of layers. The container image is associated with the application. The computer-implemented method further includes determining, by the computer, a first layer of the set of layers is modified. The determination is based on a first hash-based identifier of a set of entities associated with the first layer. The computer-implemented method further includes determining, by the computer, a presence of a first dependency relationship between the first layer and at least a second layer of the set of layers based on the dependency graph. The dependency graph is indicative of a plurality of dependency relationships between the set of layers. The plurality of dependency relationships is inclusive of the first dependency relationship. The computer-implemented method further includes modifying, by the computer, the at least second layer based on the determination of the presence of the first dependency relationship. The computer-implemented method further includes modifying, by the computer, the container image based on the modified first layer and the modified at least second layer. The computer-implemented method further includes outputting, by the computer, the modified container image. It is to be noted that a person with ordinary skill in the art will understand that the first layer and the at least second layer might not need to be consecutive layers, the first layer and the at least second layer can be any layers from the set of layers that are dependent on each other. For example, “layer 1” can be the first layer and “layer 5” can be the second layer.

In various embodiments of the disclosure, the computer-implemented method further includes modifying, by the computer, the dependency graph based on the modified first layer and the modified at least second layer. The modified dependency graph is indicative of a plurality of modified dependency relationships between the set of layers. The computer-implemented method further includes outputting, by the computer, the modified dependency graph. It is to be noted that a person with ordinary skill in the art will understand that the first layer and the at least second layer might not need to be consecutive layers, the first layer and the at least second layer can be any layers from the set of layers that are dependent on each other.

In various embodiments of the disclosure, the computer-implemented method further includes determining, by the computer, a presence of a second dependency relationship between the modified at least second layer and at least a third layer of the set of layers based on the modified dependency graph. The plurality of modified dependency relationships is inclusive of the second dependency relationship. The computer-implemented method further includes modifying, by the computer, the at least third layer based on the determination of the presence of the second dependency relationship. The computer-implemented method further includes modifying, by the computer, the dependency graph based on the modified at least third layer. The computer-implemented method further includes modifying, by the computer, the container image based on the modified dependency graph. It is to be noted that a person with ordinary skill in the art will understand that the at least second layer and the at least third layer might not need to be consecutive layers, the at least second layer and the at least third layer can be any layers from the set of layers that are dependent on each other.

In various embodiments of the disclosure, the computer-implemented method further includes generating, by the computer, the first hash-based identifier of the set of entities associated with the first layer. The computer-implemented method further includes extracting, by the computer, a second hash-based identifier of the set of entities associated with the first layer from cache data associated with the set of layers. The computer-implemented method further includes comparing, by the computer, the first hash-based identifier associated with the first layer with the second hash-based identifier associated with the first layer. The computer-implemented method further includes determining, by the computer, the first layer is modified, based on the comparison. In case the first hash-based identifier of the set of entities associated with the first layer (calculated based on a set of instructions) is different (or not equal) to the second hash-based identifier of the set of entities associated with the first layer (extracted from the cache data), then the computer-implemented method determines that the first layer is modified.

In various embodiments of the disclosure, the computer-implemented method further includes retrieving, by the computer, input data including a set of instructions associated with the application. The computer-implemented method further includes parsing, by the computer, the set of instructions. The computer-implemented method further includes generating, by the computer, the first hash-based identifier of the set of entities associated with the first layer based on the parsed set of instructions.

In various embodiments of the disclosure, the computer-implemented method further includes determining, by the computer, the presence of the first dependency relationship between the first layer and the at least second layer based on the cache data. The computer-implemented method further includes generating, by the computer, the dependency graph including a set of nodes mapped to the set of layers and the cache data associated with the set of layers. The dependency graph is generated based on the determination of the presence of the first dependency relationship. The computer-implemented method further includes generating, by the computer, the modified container image based on the dependency graph and the set of instructions.

In various embodiments of the disclosure, the computer-implemented method further includes determining, by the computer, the set of entities associated with each layer of the set of layers. The computer implemented method further includes determining, by the computer, an entity of set of entities is associated with each of the first layer and the at least second layer. The computer-implemented method further includes determining, by the computer, the presence of the first dependency relationship based on the determination that the entity of the set of entities is associated with each of the first layer and the at least second layer.

In various embodiments of the disclosure, each entity of the set of entities corresponds to at least one of a folder or an accessed file.

In various embodiments of the disclosure, the cache data further includes the set of entities and a set of hash-based identifiers associated with the set of entities. Each hash-based identifier of the set of hash-based identifiers corresponds to at least one of a hash value or a checksum value.

In various embodiments of the disclosure, a computer system for modification of container image of an application using a dependency graph is described. The computer system includes a processor set, one or more computer-readable storage media, and program instructions stored on the one or more computer-readable storage media. The program instructions are executable by the processor set and cause the processor set to retrieve the container image that includes a set of layers. The container image is associated with the application. The program instructions further cause the processor set to determine a first layer of the set of layers is modified. The determination is based on a first hash-based identifier of a set of entities associated with the first layer. The program instructions further cause the processor set to determine a presence of a first dependency relationship between the first layer and at least a second layer of the set of layers based on the dependency graph. The dependency graph is indicative of a plurality of dependency relationships between the set of layers. The plurality of dependency relationships is inclusive of the first dependency relationship. The program instructions further cause the processor set to modify the at least second layer based on the determination of the presence of the first dependency relationship. The program instructions further cause the processor set to modify the container image based on the modified first layer and the modified at least second layer. The program instructions further cause the processor set to output the modified container image. It is to be noted that a person with ordinary skill in the art will understand that the first layer and the at least second layer might not need to be consecutive layers, the first layer and the at least second layer can be any layers from the set of layers that are dependent on each other.

In various embodiments of the disclosure, the program instructions further cause the processor set to modify the dependency graph based on the modified first layer and the modified at least second layer. The modified dependency graph is indicative of a plurality of modified dependency relationships between the set of layers. The program instructions further cause the processor set to output the modified dependency graph.

In various embodiments of the disclosure, the program instructions further cause the processor set to determine a presence of a second dependency relationship between the modified at least second layer and at least a third layer of the set of layers based on the modified dependency graph. The plurality of modified dependency relationships is inclusive of the second dependency relationship. The program instructions further cause the processor set to modify the at least third layer based on the determination of the presence of the second dependency relationship. The program instructions further cause the processor set to modify the dependency graph based on the modified at least third layer. The program instructions further cause the processor set to modify the container image based on the modified dependency graph.

In various embodiments of the disclosure, the program instructions further cause the processor set to generate the first hash-based identifier of the set of entities associated with the first layer. The program instructions further cause the processor set to extract a second hash-based identifier of the set of entities associated with the first layer from cache data associated with the set of layers. The program instructions further cause the processor set to compare the first hash-based identifier associated with the first layer with the second hash-based identifier associated with the first layer. The program instructions further cause the processor set to determine the first layer is modified based on the comparison. In case the first hash-based identifier of the set of entities associated with the first layer (calculated based on a set of instructions) is different (or not equal) to the second hash-based identifier of the set of entities associated with the first layer (extracted from the cache data), then the computer system determines that the first layer is modified.

In various embodiments of the disclosure, the program instructions further cause the processor set to retrieve input data that includes a set of instructions associated with the application. The program instructions further cause the processor set to parse the set of instructions. The program instructions further cause the processor set to generate the first hash-based identifier of the set of entities associated with the first layer based on the parsed set of instructions.

In various embodiments of the disclosure, the program instructions further cause the processor set to determine the presence of the first dependency relationship between the first layer and the at least second layer based on the cache data. The program instructions further cause the processor set to generate the dependency graph that includes a set of nodes mapped to the set of layers and the cache data associated with the set of layers. The dependency graph is generated based on the determination of the presence of the first dependency relationship. The program instructions further cause the processor set to generate the modified container image based on the dependency graph and the set of instructions.

In various embodiments of the disclosure, the program instructions further cause the processor set to determine the set of entities associated with each layer of the set of layers. Each entity of the set of entities corresponds to at least one of a folder or an accessed file. The program instructions further cause the processor set to determine an entity of the set of entities is associated with each of the first layer and the at least second layer. The program instructions further cause the processor set to determine the presence of the first dependency relationship based on the determination that the entity of the set of entities is associated with each of the first layer and the at least second layer.

In various embodiments of the disclosure, the cache data further includes the set of entities and a set of hash-based identifiers associated with the set of entities. Each hash-based identifier of the set of hash-based identifiers corresponds to at least one of a hash value or a checksum value. The set of hash-based identifiers is exclusive of the first hash-based identifier and inclusive of the second hash-based identifier.

In various embodiments of the disclosure, a computer-program product for modification of a container image of an application using a dependency graph is described. The computer program product includes one or more computer-readable storage media and program instructions stored in the one or more computer-readable storage media to perform operations that include retrieving the container image including a set of layers. The container image is associated with the application. The operations further include determining a first layer of the set of layers is modified. The determination is based on a first hash-based identifier of a set of entities associated with the first layer. The operations further include determining an absence of a first dependency relationship between the first layer and at least a second layer of the set of layers based on a dependency graph. The dependency graph is indicative of a plurality of dependency relationships between the set of layers. The plurality of dependency relationships is inclusive of the first dependency relationship. The operations further include modifying the container image using the modified first layer based on the determination of the absence of the first dependency relationship. The operations further include outputting the modified container image.

In various embodiments of the disclosure, the operations further include generating a second hash-based identifier of the set of entities associated with the at least second layer based on the determination of the absence of the first dependency relationship. The operations further include extracting a third hash-based identifier of the set of entities associated with the at least second layer from cache data associated with the set of layers. The operations further include comparing the second hash-based identifier associated with the at least second layer with the third hash-based identifier associated with the at least second layer. The operations further include modifying the at least second layer based on the comparison.

In various embodiments of the disclosure, the operations further include retrieving a set of instructions associated with the application. The operations further include parsing the retrieved set of instructions. The operations further include generating the first hash-based identifier of the set of entities associated with the first layer based on the parsed set of instructions. The operations further include extracting a second hash-based identifier of the set of entities associated with the first layer from cache data associated with the set of layers. The operations further include comparing the first hash-based identifier associated with the first layer with the second hash-based identifier associated with the first layer. The operations further include determining that the first layer is modified, based on the comparison.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

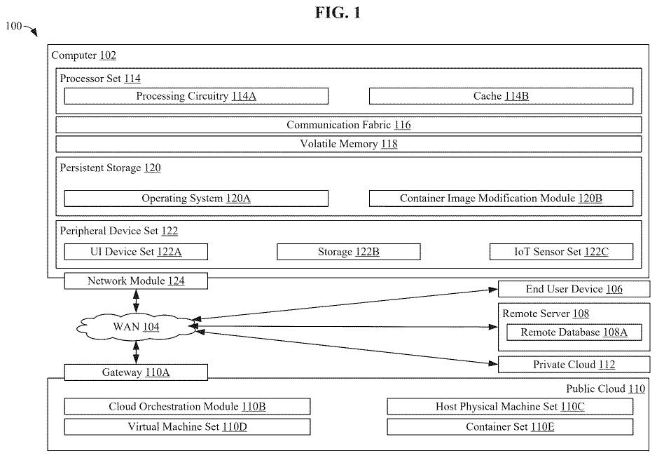

FIG. 1 is a diagram that illustrates a computing environment for modification of container image of an application using a dependency graph, in accordance with an embodiment of the disclosure. With reference to FIG. 1, there is shown a computing environment 100 that contains an example of an environment for the execution of at least some of the computer code involved in performing the disclosed methods, such as a container image modification module 120B. In addition to the container image modification module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the container image modification module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that can run a program, access a network or query a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not needed to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the container image modification module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the container image modification module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

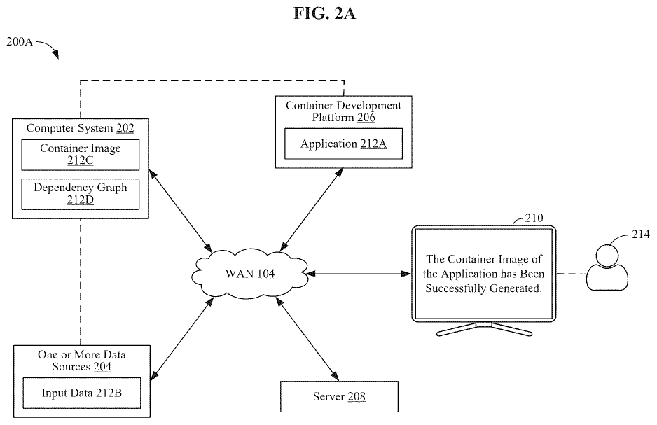

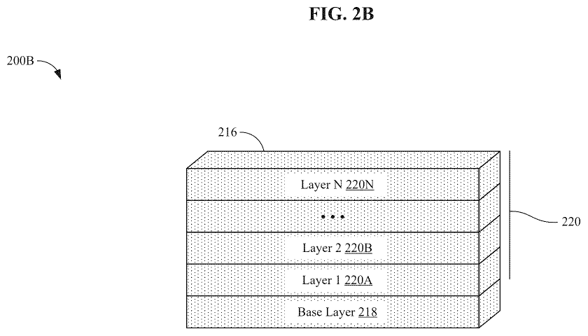

FIG. 2A is a diagram that illustrates an environment for modification of a container image of an application using a dependency graph, in accordance with an embodiment of the disclosure. FIG. 2A is explained in conjunction with elements from FIG. 1. With reference to FIG. 2A, there is shown a diagram of a network environment 200A. The network environment 200A includes a computer system 202, one or more data sources 204, a container development platform 206, a server 208, and a user device 210. The container development platform 206 generates a container image (container image 212C) of an application 212A. The one or more data sources 204 includes input data 212B. The user device 210 is further associated with a user 214. The network environment 200A further includes the WAN 104 of FIG. 1. In an embodiment of the disclosure, the user device 210 is an exemplary embodiment of the EUD 106. Similarly, the computer system 202 is an exemplary embodiment of the computer 102 in FIG. 1.

The computer system 202 includes suitable logic, circuitry, code, and/or interfaces that are configured to modify the container image 212C of the application 212A during a build phase (or the generation phase) of the container image 212C. The computer system 202 retrieves the container image 212C which includes a set of layers associated with the application 212A. The computer system 202 further determines that a first layer of the set of layers is modified, based on a first hash-based identifier of a set of entities associated with the first layer. The computer system 202 further determines a presence of a first dependency relationship between the first layer and at least a second layer of the set of layers based on a dependency graph 212D. The dependency graph 212D is indicative of a plurality of dependency relationships between the set of layers. The plurality of dependency relationships is inclusive of the first dependency relationship. The computer system 202 further modifies the at least second layer based on the determination of the presence of the first dependency relationship. The computer system 202 further modifies the container image 212C of the application 212A based on the modified first layer and the modified at least second layer. The computer system 202 further outputs the modified container image 212C.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the computer system 202 may be embodied as a cloud-based service, a cloud-based application, a cloud-based platform, a remote server-based service, a remote server-based application, a remote server-based platform, or a virtual computing system.

Each data source of the one or more data sources 204 corresponds to an organized collection of data that may be stored and accessed electronically from a computer system (such as the computer system 202). Each of the one or more data sources 204 may be designed to manage, store, retrieve, and update data efficiently. In an exemplary implementation, each data source of the one or more data sources 204 may correspond to a database. In such an implementation, the structure of the database corresponding to each data source of the one or more data sources 204 typically involves tables, records, and fields that can be managed through various database management systems (DBMS).

In an embodiment of the disclosure, the one or more data sources 204 are connected to the application programming interfaces (APIs) of the container development platform 206. In an embodiment of the disclosure, each data source of the one or more data sources 204 stores the input data 212B. The input data 212B includes a first set of instructions and a second set of instructions associated with the application 212A. In an embodiment of the disclosure, the computer system 202 utilizes each instruction of the first set of instructions and the second set of instructions to generate the container image 212C of the application 212A. Specifically, each instruction of the first set of instructions generates a corresponding layer in the set of layers of the container image 212C of the application 212A.

Examples of each instruction of the first set of instructions include at least one of, but are not limited to, a “RUN” instruction, an “ADD” instruction, a “FROM” instruction, a “COPY” instruction, or the like. Examples of each instruction of the second set of instructions include at least one of, but are not limited to, a “CMD” instruction, an “ENTRYPOINT” instruction, or the like. Each instruction of the second set of instruction does not create any new layer (or the corresponding layer) in the set of layers of the container image. Examples of each data source of one or more data sources 204 may include but are not limited to, a relational database, a Non-Structured Query Language (SQL) database, a hierarchical database, a network database, a transactional database, a data warehouse, and a distributed database.

The container development platform 206 includes suitable logic, code, and circuitry that is configured to facilitate the creation, deployment, and management of container images of applications within lightweight, portable containers. The container development platform 206 ensures that applications, along with their dependencies, are encapsulated in a manner that guarantees consistent performance across various computing environments, thereby addressing compatibility issues that may arise during the software development lifecycle. The architecture of the container development platform 206 allows for efficient resource utilization, rapid deployment, and seamless scalability, enabling organizations to manage their operational workflows and enhance productivity.

In an embodiment of the disclosure, the container development platform 206 generates the container image 212C of the application 212A. The container development platform 206 utilizes the input data 212B (specifically the first set of instructions and the second set of instructions) to generate the container image 212C of the application 212A. The container development platform 206 utilizes each instruction of the first set of instructions to generate the corresponding layer in the set of layers of the container image 212C of the application 212A.

In an embodiment of the disclosure, the container development platform 206 is implemented as a plurality of distributed cloud-based resources by use of several technologies that are well known to those ordinarily skilled in the art. A person with ordinary skill in the art will understand that the scope of the disclosure may not be limited to the implementation of the container development platform 206 and the computer system 202 as two separate entities. In certain embodiments, the functionalities of the container development platform 206 can be incorporated in its entirety or at least partially in the computer system 202, without a departure from the scope of the disclosure. Examples of container development platforms include Docker®, which is widely recognized for its comprehensive toolset and user-friendly interface.

The server 208 includes suitable logic, circuitry, interfaces, and/or code that stores the first set of instructions. The server 208 can be implemented as a cloud server and may execute operations through web applications, cloud applications, HTTP requests, repository operations, file transfer, and the like. Various example implementations of the server 208 include but are not limited to, a database server, a file server, a web server, a media server, an application server, a mainframe server, or a cloud computing server.

In an embodiment of the disclosure, the server 208 is implemented as a plurality of distributed cloud-based resources by use of several technologies that are well known to those ordinarily skilled in the art. A person with ordinary skill in the art will understand that the scope of the disclosure may not be limited to the implementation of the server 208 and the computer system 202 as two separate entities. In certain embodiments, the functionalities of the server 208 can be incorporated in its entirety or at least partially in the computer system 202, without a departure from the scope of the disclosure.

The user device 210 includes suitable logic, circuitry, and/or interfaces that are configured to execute one or more tasks within the network environment 200A. The user device 210 performs the one or more tasks such as receiving data, processing the data, and transmitting the data. In an embodiment of the disclosure, the computer system 202 receives the input data 212B from the user device 210. The computer system 202 receives the first set of instructions and the second set of instructions from the user device 210.

In an alternate embodiment of the disclosure, the computer system 202 renders a message on the user device 210. The message is associated with the generation of the container image 212C of the application 212A. By way of example, and not by limitation, the message may be “The container image of the application has been successfully generated”. Examples of the user device 210 include one but are not limited to, a smartphone, a cellular phone, a mobile phone, a consumer electronic (CE) device, an Internet of Things (IoT) device, a computing device, a mainframe machine, a server, a computer workstation, or the like.

The application 212A includes suitable logic and/or code that is designed to perform specific tasks or functions, which can range from web services to data processing tools. Specifically, the application 212A is built using various programming languages and frameworks, and the application 212A relies on specific dependencies and configurations to operate effectively. By way of example, and not by limitation, the application 212A could be a website that serves dynamic content, a database management system, a microservice that handles user authentication, and the like.

The container image 212C of the application 212A is a lightweight, standalone, and executable package that includes suitable logic and/or code that is needed to run the application on various container orchestration platforms. The container image 212C includes application code, runtime environment, libraries, and system tools associated with the application 212A that is needed to run the application 212A on the various container orchestration platforms. The container image 212C further includes the set of layers associated with the application 212A. Each layer of the set of layers represents a specific change or addition to the image.

The set of layers further includes a base layer and the set of layers. In an embodiment of the disclosure, the computer system 202 stacks each layer of the set of layers on top of each-other, allowing for efficient storage and data sharing. This layered architecture of the container image 212C reduces the size of the container image 212C and manages version control and reuse of components. Specifically, the computer system 202 utilizes each instruction of the first set of instructions to generate the corresponding layer in the set of layers of the container image 212C of the application 212A. The computer system 202 further stores the information (the accessed files and the folders) of each layer of the set of layers in cache data of each layer of the set of layers. Details about the layered architecture of the container image 212C are further provided, for example, in FIG. 2B.

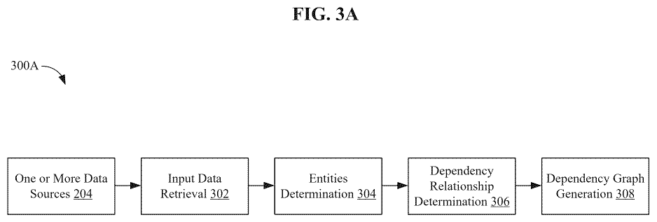

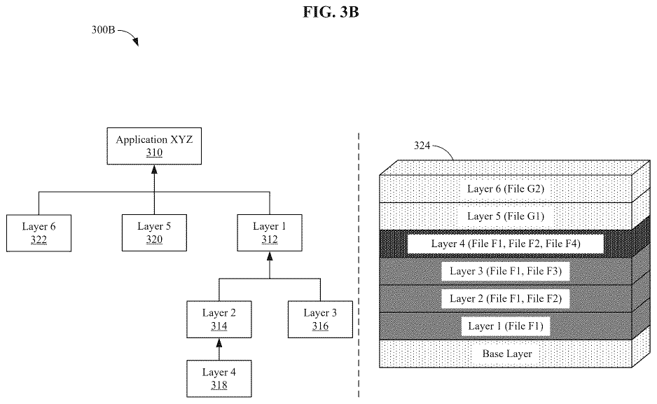

The dependency graph 212D is a data structure that corresponds to an organized collection of data that is used to store the information (the cache data) associated with the set of layers of the container image 212C of the application 212A. In an embodiment of the disclosure, the computer system 202 generates the dependency graph 212D based on the cache data associated with the set of layers. The dependency graph 212D further includes a set of nodes mapped to the set of layers of the container image 212C of the application 212A. The cache data includes a set of entities (accessed files and folders) associated with each entity of the set of entities and a set of hash-based identifiers associated with the set of entities. Details about the generation of the dependency graph are further provided, for example, in FIG. 3A and FIG. 3B.

In operation, computer system 202 retrieves the container image 212C which includes the set of layers associated with the application. In an embodiment of the disclosure, the computer system 202 retrieves the container image 212C from the container development platform 206 during the build phase (or the generation phase) of the container image 212C. In an alternate embodiment of the disclosure, the computer system 202 retrieves the container image 212C from the one or more data sources 204. As discussed above, the one or more data sources 204 are connected with the APIs of the container development platform 206. In an embodiment of the disclosure, the computer system 202 obtains the container image 212C via API calls.

As discussed above the container image 212C includes the base layer and the set of layers. The cache data of the base layer includes critical information associated with the container image 216 such as an image identifier, a creation date, and the like. The set of layers are the layers that include the application code, libraries, and system tools associated with the application that is needed to run the application on the various container orchestration platforms. The cache data of each layer of the set of layers stores the files and folders (the set of entities) accessed by the corresponding layer of the set of layers. The cache data of each layer of the set of layers further includes a specific hash-based identifier of the set of entities associated with the corresponding layer.

Thereafter, the computer system 202 determines that the first layer of the container image 212C of the application 212A is modified, based on the first hash-based identifier of the set of entities associated with the first layer. Specifically, the computer system 202 retrieves and parses each instruction of the first set of instructions to generate (or calculate) the first hash-based identifier (a hash value or a checksum value) of the accessed files and folders associated with the first layer. Then, the computer system 202 extracts a second hash-based identifier of the accessed files and folders associated with the first layer from the cache data. In case the first hash-based identifier and the second hash-based identifier are different, then the computer system 202 determines that the first layer of the container image 212C is modified (specifically, the accessed files and the folders associated with the first layer are modified).

By way of example, and not by limitation, the computer system 202 retrieves the first set of instructions from the one or more data sources 204. The first set of instructions can be represented in Table 1 below:

TABLE 1
First Set of Instructions

| | | Corresponding |
|---|---|---|
| S. No. | Instructions | Layer |
| 1 | FROM image:version | Layer 1 |
| 2 | COPY binary1 in /opt/usr/binary1 | Layer 2 |
| 3 | COPY binary2 in /opt/usr/binary2 | Layer 3 |
| 4 | COPY input_file in /home/user/input_file | Layer 4 |
| 5 | RUN /opt/usr/binary1 /home/user/input_file | Layer 5 |

By way of example, and not by limitation, the contents of the “binary 1” file are updated. In that case, the “layer 2” of the container image 212C is modified. The computer system 202 determines that “layer 2” is modified based on the first hash-based identifier. The computer system 202 generates (or calculates) the first hash-based identifier of the set of entities associated with the “layer 2” based on the updated contents of the “binary 1” file. The computer system 202 further extracts the second hash-based identifier associated with “layer 2” from the cache data. Since the contents of the “binary 1” file are updated, therefore the first hash-based identifier and the second hash-based identifier are different and the computer system 202 determines that the “layer 2” is modified.

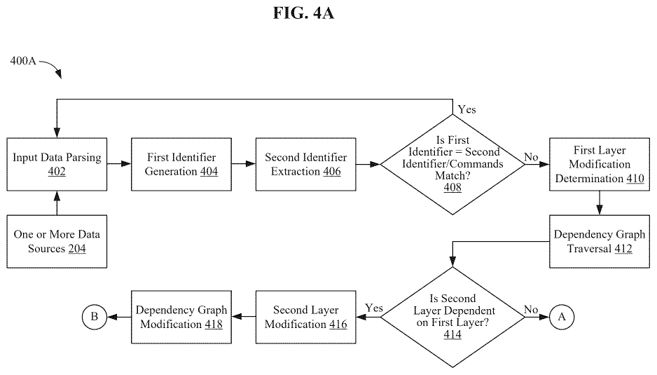

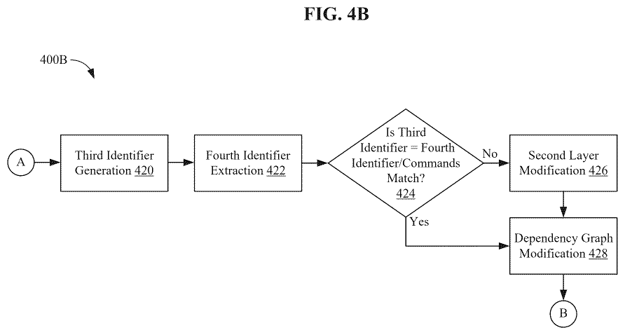

The computer system 202 further updates the cache data of the first layer based on the determination that the first layer is modified. The computer system 202 updates (or populates) the cache data of the first layer with the modified files and the folders and the first hash-based identifier of the modified files and the folders. Details about the first layer modification determination operation are provided, for example, in FIG. 4A. Since the computer system 202 determines that the first layer is modified based on the comparison between the hash values or checksum values instead of parsing the entire files, therefore, the processing time of the computer system 202 is lesser as compared to the traditional methods of container image modification.

Further, the computer system 202 determines the presence of the first dependency relationship between the first layer and at least the second layer of the set of layers of the container image based on the dependency graph 212D. The dependency graph is indicative of a plurality of dependency relationships between the set of layers. The plurality of dependency relationships is inclusive of the first dependency relationship. As discussed above, the dependency graph 212D is generated based on the cache data associated with the set of layers. The dependency graph 212D includes the set of nodes mapped to the set of layers and the cache data. The cache data includes the set of entities (the accessed files and the folders) associated with the set of layers. Dependency relationship between two layers of a specific container image exists when the two layers access common entities (common files or folders). It is to be noted that a person with ordinary skill in the art will understand that the first layer and the at least second layer might not need to be consecutive layers, the first layer and the at least second layer can be any layers from the set of layers that are dependent on each other. Details about the generation of the dependency graph are provided, for example, in FIG. 3A and FIG. 3B.

By way of example, and not by limitation, the dependency graph 212D can be represented in Table 2 below:

TABLE 2
Dependency Graph

| | | | Accessed | Checksum | Check | |
|---|---|---|---|---|---|---|
| | | | Files | Value | sum | |
| Node | | Corresponding | (Entities) | (Existing) | Value | Dependency |
| ID | Instructions | Layer | (Cache) | (Cache) | (New) | Relationship |
| 1 | FROM | Layer 1 | / | 436123723 | 436123723 | No |
| | image:version | | /var/[ . . . ] | | | Dependency |
| | | | . . . | | | |
| | | | . . . | | | |
| | | | /usr/[ . . . ] | | | |
| 2 | COPY | Layer 2 | /opt/usr/binary1 | 1234577 | 1239221 | No |
| | binary1 in | | | | | Dependency |
| | /opt/usr/ | | | | | |
| | binary1 | | | | | |
| 3 | COPY | Layer 3 | /opt/usr/binary2 | 43672723 | | No |
| | binary2 in | | | | | Dependency |
| | /opt/usr/ | | | | | |
| | binary2 | | | | | |
| 4 | COPY | Layer 4 | /home/user/ | 23535345 | | No |
| | input_file | | input_file | | | Dependency |
| | in | | | | | |
| | /home/user/ | | | | | |
| | input_file | | | | | |
| 5 | RUN | Layer 5 | /opt/usr/binary1/ | 33478234 | | Dependent on |
| | /opt/usr/ | | home/user/ | | | Layer 2 |
| | binary1/ | | input_file | | | and Layer 4 |
| | home/user/ | | | | | |
| | input_file | | | | | |

By way of example, and not by limitation, the computer system 202 determines that “layer 5” is dependent on “layer 2” based on the dependency graph. The computer system 202 determines that since both “layer 2” and “layer 5” access the same “binary 1” file, therefore the computer system 202 determines the presence of the first dependency relationship between the “layer 2” and the “layer 5”.

Thereafter, the computer system 202 modifies the at least second layer based on the determination of the presence of the first dependency relationship. Specifically, the computer system 202 modifies the set of entities (the accessed files and the folders) associated with the at least second layer based on the determination of the presence of the first dependency relationship. The computer system 202 further updates (or populates) the cache data of the at least second layer with the modified set of entities and a specific hash-based identifier of the modified set of entities. In an embodiment of the disclosure, the computer system 202 further regenerates the at least second layer based on the modified set of entities. By way of example, and not by limitation, the computer system 202 modifies the “binary 1” file in the cache data of the “layer 5” and further regenerates the “layer 5” based on the determination of the presence of the first dependency relationship.

Further, the computer system 202 modifies the container image 212C of the application 212A based on the modified first layer and the modified at least second layer. Specifically, the computer system 202 regenerates the first layer and the modified at least second layer based on the modified set of entities (modified files and folders) to modify the container image 212C of the application 212A. Since the computer system 202 regenerates only the dependent layers of the modified first layer of the container image 212C instead of regenerating each layer below the modified first layer, therefore, the processing time of the computer system 202 is lesser as compared to the traditional methods. By way of example, and not by limitation, the computer system 202 regenerates the “layer 2” and the “layer 5” to modify the container image 212C of the application 212A.

To this end, the computer system 202 outputs the modified container image. In an embodiment of the disclosure, the computer system 202 deploys the modified container image of the application 212A on the container development platform 206, and the modified container image can be hosted further on the various container orchestration platforms. In an alternate embodiment of the disclosure, the computer system 202 stores the modified container image into the server 208. In an alternate embodiment of the disclosure, the computer system 202 renders the message on the user device 210 “The container image of the application has been successfully generated”.

FIG. 2B is a diagram 200B that illustrates an exemplary layered-architecture of a container image of an application, in accordance with an embodiment of the disclosure. FIG. 2B is explained in conjunction with FIG. 1 and FIG. 2A. With reference to FIG. 2B, there is shown a container image 216 of a specific application. The container image 216 includes a base layer 218 and a set of layers 220. The set of layers 220 includes a first layer 220A, a second layer 220B, up to an Nth layer 220N. The container image 216 is an exemplary embodiment of the container image 212C.

The base layer 218 includes the information associated with the environment of the application. The cache data of the base layer 218 includes critical information associated with the container image 216 such as an image identifier, a creation date, and the like. The computer system 202 utilizes the cache data of the base layer 218 to identify the base layer and ensure its compatibility with the set of layers 220. The cache data for the base layer 218 may further store its binary contents for quick retrieval during image builds or deployments.

The set of layers 220 include the layers that stores the application code, libraries, and system tools associated with the application that is needed to run the application on the various container orchestration platforms. The cache data associated with each layer of the set of layers 220 stores the files and folders (the set of entities) accessed by the corresponding layer of the set of layers. The cache data of each layer of the set of layers further includes a specific hash-based identifier of the set of entities associated with the corresponding layer.

In an embodiment of the disclosure, the computer system 202 specifically parses the first set of instructions, generate the first hash-based identifier, and then compare the first hash-based identifier with the second hash-based identifier stored in the cache data of the first layer to identify that the first layer is modified. Based on the determination that the first layer is modified, the computer system 202 obtains the new files and the folders accessed by the first layer, updates the cache data of the first layer with the new files and the folders, and regenerates the first layer based on the new files and the folders.

FIG. 3A is a diagram that illustrates exemplary operations for generation of a dependency graph for modification of a container image of an application, in accordance with an embodiment of the disclosure. FIG. 3A is explained in conjunction with elements from FIG. 1, FIG. 2A, and FIG. 2B. With reference to FIG. 3A, there is shown the block diagram 300A that illustrates exemplary operations from 302 to 308, as described herein. The exemplary operations illustrated in the block diagram 300A start at 302 and are performed by any computing system, apparatus, or device, such as by the computer 102 of FIG. 1 or by the computer system 202 of FIG. 2A. Although illustrated with discrete blocks, the exemplary operations associated with one or more blocks of the block diagram 300A can be divided into additional blocks, combined into fewer blocks, or eliminated, depending on the implementation.

At 302, an input data retrieval operation is performed. In the input data retrieval operation, the computer system 202 retrieves the input data 212B that includes the first set of instructions, and the second set of instructions associated with the application 212A. In an embodiment of the disclosure, the computer system 202 utilizes each instruction of the first set of instructions and the second set of instructions to generate the container image 212C of the application 212A. Specifically, each instruction of the first set of instructions generates a corresponding layer in the set of layers of the container image 212C of the application 212A.

Examples of each instruction of the first set of instructions include at least one of but are not limited to, a “RUN” instruction, an “ADD” instruction, a “FROM” instruction, a “COPY” instruction, or the like. Examples of each instruction of the second set of instructions include at least one of, but are not limited to, a “CMD” instruction, an “ENTRYPOINT” instruction, or the like. By way of example, and not by limitation, the computer system 202 retrieves the first set of instructions that can be represented in Table 3 below:

TABLE 3
First Set of Instructions

| S. No. | Instructions | Corresponding Layer |
|---|---|---|
| 1 | FROM image:version | Layer 1 |
| 2 | RUN apt install mypackage | Layer 2 |
| 3 | RUN mkdir -p /mypath1 | Layer 3 |
| 4 | RUN mkdir -p /mypath2 | Layer 4 |
| 5 | COPY mybinary1 /mypath1/mybinary1 | Layer 5 |
| 6 | COPY mybinary2 /mypath1/mybinary2 | Layer 6 |
| 7 | RUN /mypath1/mybinary1 | Layer 7 |

At 304, an entities determination operation is performed. In the entities determination operation, the computer system 202 determines the set of entities (accessed files or folders) associated with the set of layers of the container image 212C of the application 212A. Specifically, the computer system 202 parses the first set of instructions to determine the set of entities associated with the set of layers of the container image 212C of the application 212A.

In an embodiment of the disclosure, each entity of the set of entities corresponds to the accessed file and the folder associated with the corresponding layer of the set of layers. By way of example and not by limitation, the set of entities can be represented in Table 4 below:

TABLE 4
Set of Entities

| S. No. | Entity | Corresponding Layer |
|---|---|---|
| 1 | / | Layer 1 |
| | /var/[ . . . ] | |
| | . . . | |
| | . . . | |
| | /usr/[ . . . ] | |
| 2 | /usr/lib/mypackage/[ . . . ] | Layer 2 |
| | /bin/mypackage | |
| | /var/lib/mypackage/[ . . . ] | |
| 3 | /mypath1 | Layer 3 |
| 4 | /mypath2 | Layer 4 |
| 5 | /mypath1/mybinary1 | Layer 5 |
| 6 | /mypath1/mybinary2 | Layer 6 |
| 7 | /mypath1/mybinary1 | Layer 7 |

At 306, a dependency relationship determination operation is performed. In the dependency relationship determination operation, the computer system 202 determines one of the presence or an absence of the first dependency relationship between the first layer of the set of layers and at least the second layer of the set of layers of the container image 212C of the application 212A based on the determined set of entities. Dependency relationship between two layers of a specific container image exists when the two layers access common entities (common files or folders). Specifically, the computer system 202 parses the set of entities (accessed files and folders) associated with the set of layers to identify common entities between the set of layers and then determine one of the presence or the absence of the first dependency relationship based on the parsed set of entities.

By way of example, and not by limitation, the first dependency relationship can be represented in Table 5 below:

TABLE 5
First Dependency Relationship

| S. | Corresponding | | |
|---|---|---|---|
| No. | Layer | Dependency Relationship | Common Entities |
| 1 | Layer 1 | No dependency | No common entities |
| 2 | Layer 2 | No dependency | No common entities |
| 3 | Layer 3 | No dependency | No common entities |
| 4 | Layer 4 | No dependency | No common entities |
| 5 | Layer 5 | Dependent on Layer 3 | mypath1 |
| 6 | Layer 6 | Dependent on Layer 3 | mypath1 |
| 7 | Layer 7 | Dependent on Layer 3 and | mypath1, mybinary1 |
| | | Layer 5 | |

At 308, a dependency graph generation operation is performed. In the dependency graph generation operation, the computer system 202 generates the dependency graph 212D associated with the container image 212C of the application 212A. The computer system 202 determines the cache data associated with each layer of the set of layers and then generates the dependency graph based on the cache data associated with the set of layers. The cache data includes the determined set of entities associated with each layer of the set of layers and the set of hash-based identifiers (checksum values or hash values) associated with each entity of the set of entities. The dependency graph 212D includes the set of nodes mapped to the set of layers and the cache data.

In an embodiment of the disclosure, each hash-based identifier of the set of hash-based identifiers corresponds to a hash value or a checksum value. By way of example, and not by limitation, the dependency graph 212D can be represented in Table 6 below:

TABLE 6
Dependency Graph

| | | | Accessed | Checksum | | |
|---|---|---|---|---|---|---|
| | | | Files | Value | Checksum | |
| Node | | Corresponding | (Entities) | (Existing) | Value | Dependency |
| ID | Instructions | Layer | (Cache) | (Cache) | (New) | Relationship |
| 1 | FROM | Layer 1 | / | 436123723 | 436123723 | No |
| | image:version | | /var/[ . . . ] | | | Dependency |
| | | | . . . | | | |
| | | | . . . | | | |
| | | | /usr/[ . . . ] | | | |
| 2 | RUN | Layer 2 | /usr/lib/ | 1234577 | 1234577 | No |
| | apt install | | mypackage/[ . . . ] | | | Dependency |
| | mypackage | | /bin/mypackage/ | | | |
| | | | var/lib/ | | | |
| | | | mypackage/[ . . . ] | | | |
| 3 | RUN | Layer 3 | /mypath1 | 43672723 | 51126674 | No |
| | mkdir -p/ | | | | | Dependency |
| | mypath1 | | | | | |
| 4 | RUN | Layer 4 | /mypath2 | 23535345 | | No |
| | mkdir -p/ | | | | | Dependency |
| | mypath2 | | | | | |
| 5 | COPY | Layer 5 | /mypath1/ | 33478234 | | Dependent |
| | mybinary1/ | | mybinary1 | | | on Layer 3 |
| | mypath1/ | | | | | |
| | mybinary1 | | | | | |
| 6 | COPY | Layer 6 | /mypath1/ | 52192245 | | Dependent |
| | mybinary2/ | | mybinary2 | | | on Layer 3 |
| | mypath1/ | | | | | |
| | mybinary2 | | | | | |
| 7 | RUN | Layer 7 | /mypath1/ | 87326631 | | Dependent |
| | /mypath1/ | | mybinary1 | | | on Layer 3 |
| | mybinary1 | | | | | and Layer 5 |

FIG. 3B is a diagram that illustrates an exemplary scenario for modification of a container image of an application, in accordance with an embodiment of the disclosure. FIG. 3B is explained in conjunction with elements from FIG. 1, FIG. 2A, FIG. 2B, and FIG. 3A. With reference to FIG. 3B, there is shown a dependency graph 310. The dependency graph 310 includes a first node 312, a second node 314, a third node 316, a fourth node 318, a fifth node 320, and a sixth node 322. With reference to FIG. 3B, there is further shown a container image 324. The dependency graph 310 is associated with the container image 324 of the application XYZ. The dependency graph 310 is an exemplary embodiment of the dependency graph 212D of FIG. 2A. The container image 324 is an exemplary embodiment of the container image 212C of FIG. 2A.

As discussed above, the computer system 202 generates the dependency graph 310 that includes the set of nodes mapped to the set of layers and the cache data associated with each layer of the set of layers 220. The cache data associated with the dependency graph 310 includes the information associated with each layer of the set of layers of the container image 324 of the application XYZ. The first node 312 is mapped to a first layer “Layer 1” of the container image of the application XYZ. The cache data of the first node 312 includes the set of entities associated with the first layer and a specific hash-based identifier associated with the set of entities of the first layer.

The second node 314 is mapped to a second layer “Layer B” of the container image 324 of the application XYZ. As illustrated in FIG. 3B, since the second node 314 is a sub-node of the first node 312, therefore, “Layer 2” is dependent on “Layer 1”. Layer 2 shares a common file “File F1” with Layer 1. The cache data of the second node 314 includes the set of entities associated with the second layer. The second layer access common entities (common file “File F1”) of the first layer due to which the second layer “Layer 2” is dependent on the first layer “Layer 1”. Similarly, the third node 316 (mapped to the third layer “Layer 3”) is also a sub-node of the first node 312, therefore, “Layer 3” is also dependent on “Layer 1”. Further, the third layer also accesses the common entities (common file “File F1”) of the first layer.

The fourth node 318 (mapped to the fourth layer “Layer 4”) is a sub-node of both the first node 312 and the second node 314. Therefore, the fourth layer “Layer 4” is dependent on both the first layer “Layer 1” and the second layer “Layer 2”. The fourth layer accesses common entities (common files “File F1” and “File F2”) of both the first layer “Layer 1” and the second layer “Layer 2”. The fifth node (mapped to the fifth layer “Layer 5”) and the sixth layer (mapped to the sixth layer “Layer 6”) include the cache data associated with the fifth layer and the sixth layer, respectively.

By way of example, and not by limitation, the dependency graph 300B can be also represented in Table 7 below:

TABLE 7
Dependency Graph

| Node | Corresponding | | |
|---|---|---|---|
| ID | Layer | Files and Folders | Dependency Relationship |
| 1 | Layer 1 | File F1 | No dependency |
| 2 | Layer 2 | File F1, File F2 | Dependent on Layer A |
| 3 | Layer 3 | File F1, File F3 | Dependent on Layer A |
| 4 | Layer 4 | File F1, File F2, | Dependent on Layer A and |
| | | File F4 | Layer B |
| 5 | Layer 5 | File G1 | No dependency |
| 6 | Layer 6 | File G2 | No dependency |

FIG. 4A is a diagram that illustrates first exemplary operations for modification of a dependency graph for modification of a container image of an application, in accordance with an embodiment of the disclosure. FIG. 4A is explained in conjunction with elements from FIG. 1, FIG. 2A, FIG. 2B, FIG. 3A, and FIG. 3B. With reference to FIG. 4A, there is shown the block diagram 400A that illustrates exemplary operations from 402 to 418, as described herein. The exemplary operations illustrated in the block diagram 400A start at 402 and are performed by any computing system, apparatus, or device, such as by the computer 102 of FIG. 1 or by the computer system 202 of FIG. 2A. Although illustrated with discrete blocks, the exemplary operations associated with one or more blocks of the block diagram 400A can be divided into additional blocks, combined into fewer blocks, or eliminated, depending on the implementation.

At 402, an input data parsing operation is performed. In the input data parsing operation, the computer system 202 parses the input data 212B that includes the first set of instructions and the second set of instructions. Specifically, the computer system 202 parses the first set of instructions to determine the set of entities associated with the set of layers of the container image 212C of the application 212A. Details about the set of entities determination operation are provided, for example, in FIG. 3A. By way of example, and not by limitation, the computer system 202 parses the instruction “RUN mkdir -p/mypath1” (provided in Table 6) to determine that the set of entities associated with the “Layer 3” is a folder “mypath1”.

At 404, a first identifier generation operation is performed. In the first identifier generation operation, the computer system 202 generates the first hash-based identifier of the set of entities associated with the first layer of the container image 212C of the application 212A. The computer system 202 generates the first hash-based identifier based on the parsed first set of instructions. In an embodiment of the disclosure, the first hash-based identifier corresponds to a hash value, or a checksum value of the entity (the file or the folder) associated with the first layer. The hash value is a fixed sized string of characters generated by a hash function that uniquely represents the contents of the entity (the file or the folder). In an embodiment, the first hash-based identifier is the checksum of the accessed files and folders. For example, the first hash-based identifier the checksum of base image in FROM instructions, the checksum of the accessed files and folders in COPY/ADD instructions; and not available in case of RUN instructions.

By way of example, and not by limitation, the hash function can be Message Digest Algorithm 5 (MD5) or Secure Hash Algorithm 2 (SHA-2). Details about the MD5 algorithm and the SHA-2 algorithm are known in the art and have been omitted for the sake of brevity. By way of example, and not by limitation, the contents of the folder “mypath1” are updated. The computer system 202 generates (or calculates) the first hash-based identifier (checksum value) of the updated contents of the folder “mypath1” as “51126674”.

At 406, a second identifier extraction operation is performed. In the second hash identifier extraction operation, the computer system 202 extracts the second hash-based identifier from the cache data of the first layer in the dependency graph 212D. The second hash-based identifier corresponds to a historical hash value of the set of entities associated with the first layer calculated during the initial build of the first layer. In an embodiment, the computer system 202 calculates the historical hash value (the second hash-based) identifier similarly by using the hash function and stores it into the cache data. As discussed above, the dependency graph 212D stores the cache data associated with the set of layers of the container image 212C. The cache data includes the set of entities (the files and the folders) associated with the set of layers and the set of hash-based identifiers (the checksum values) of the accessed files and folders associated with the set of layers.

By way of example, and not by limitation, the computer system 202 extracts the checksum value of the contents of the folder “mypath1” from the cache data of the “Layer 3” in the dependency graph as “43672723”.

At 408, it is determined that the first hash-based identifier is equal to the second hash-based identifier. In an embodiment of the disclosure, the computer system 202 compares the first hash-based identifier with the second hash-based identifier. In an embodiment of the disclosure, the computer system 202 determines that the first hash-based identifier is equal (identical) to the second hash-based identifier based on the comparison. In an alternate embodiment of the disclosure, the computer system 202 determines that the first hash-based identifier is not equal (different) to the second hash-based identifier based on the comparison. In an alternate embodiment, the computer system 202 further compares the commands in the first set of instructions with the instructions stored in the cache data to determine that the first layer is modified. In case the commands in the first set of instructions does not match the commands stored in the cache, the computer system 202 determines that the first layer is modified. In an alternate embodiment, the computer system 202 further parses the files and the folders to determine that the contents of the files and folders of first layer have been changed. In case the contents of the files and folders of first layer have been changed, the computer system 202 determines that the first layer is modified.

Based on the determination that the first hash-based identifier is equal to the second hash-based identifier, the control of operations moves back to 402 to again parse the input data 212B and determine whether the set of layers (excluding the first layer) are modified based on the set of hash-based identifiers. Based on the determination that the first hash-based identifier is not equal to the second hash-based identifier, the control of operations proceeds to 410 to determine whether the at least second layer is dependent on the first layer and a modification is needed. Further, based on the determination that the commands in the first set of instructions and the instructions stored in the cache data does not match, the control of operations proceeds to 410, otherwise the control of operations moves back to 402. Further, based on the determination that contents of all the files and folders of the first layer has not changed, the control of operations moves back to 402, otherwise the control of operations proceeds to 410.

By way of example, and not by limitation, the computer system 202 determines that the extracted checksum value “43672723” and the generated checksum value “51126674” are different that indicates that the contents of the folder “mypath1” are modified. Since the computer system 202 determines that the first layer is modified based on the comparison between hash-based identifiers and not by parsing the contents of the files and the folders, therefore, the processing time of the computer system 202 is lesser as compared to the traditional methods.

At 410, a first layer modification determination operation is performed. In the first layer modification determination operation, the computer system 202 determines that the first layer of the container image 212C of the application is modified based on the first hash-based identifier of the set of entities associated with the first layer. Specifically, the computer system 202 determines that the first layer (specifically, the files and the folders of the first layer) is modified based on the comparison between the first hash-based identifier and the second hash-based identifier as discussed above. Based on the determination that the first layer is modified, the computer system 202 updates the cache data of the first layer with the first hash-based identifier and the modified files and the folders of the first layer. The computer system 202 further regenerates the first layer based on the modified files and folders.

By way of example, and not by limitation, the computer system 202 determines that the ‘layer 3” of the container image of the application is modified since the extracted checksum value “43672723” and the generated checksum value “51126674” are different. The computer system 202 further modifies the contents of the folder “mypath1” in the container image and in the dependency graph 212D as well and further modifies the checksum value in the cache data of the dependency graph 212D. The computer system 202 further regenerates the modified first layer “layer 3” based on the modified set of entities.

At 412, a dependency graph traversal operation is performed. In the dependency graph traversal operation, the computer system 202 traverses the dependency graph based on the determination that the first layer of the container image 212C of the application is modified. The computer system 202 traverses the dependency graph 212D to determine whether the at least second layer is dependent on the first layer and the modification is needed in the at least second layer as well.

Specifically, the computer system 202 traverses the cache data (the set of entities or the files and the folders from the cache) to determine whether the at least second layer is dependent on the first layer). By way of example, and not by limitation, the computer system 202 traverses the cache data of the dependency graph 212D provided in Table 6.

At 414, it is determined that the at least second layer is dependent on the first layer. In an embodiment of the disclosure, the computer system 202 determines one of the presence or the absence of the first dependency relationship between the first layer and the at least second layer of the container image 212C of the application 212A based on the traversal of the dependency graph 212D. In an embodiment of the disclosure, the computer system 202 determines one of the presence or the absence of the first dependency relationship based on the traversed cache data (the traversed set of entities from the cache).

Based on the determination that the at least second layer is dependent on the first layer, the control of operations proceeds to 416 to modify the dependent at least second layer and accordingly modify the container image. Based on the determination that the at least second layer is not dependent on the first layer, the control of proceeds to 420, to determine whether the at least second layer needs modification (not based on the first dependency relationship with the first layer but based on the entities (the files and the folders) associated with the at least second layer).

By way of example, and not by limitation, the computer system 202 determines the presence of the first dependency relationship between “layer 3” (the first layer), “layer 5”, “layer 6” and “layer 7” since “layer 3”, “layer 5”, “layer 6”, “layer 7” access the common entity (the folder “mypath1”). Therefore, “layer 5”, “layer 6” and “layer 7” are dependent on “layer 3” (provided in dependency graph given in Table 6). Further, the computer system 202 determines the absence of the first dependency relationship between “layer 3” and “layer 4” since the “layer 3” and “layer 4” do not access the common entity.

At 416, a second layer modification operation is performed. In the second layer modification operation, the computer system 202 modifies the at least second layer based on the determination that the at least second layer is dependent on the first layer. In an embodiment of the disclosure, the computer system 202 modifies the at least second layer based on the determination of the presence of the first dependency relationship. Specifically, the computer system 202 modifies the set of entities (the accessed files and the folders) associated with the at least second layer based on the determination of the presence of the first dependency relationship.

The computer system 202 further modifies the cache data of the at least second layer with the modified files and the folders of the at least second layer. In an embodiment of the disclosure, the computer system 202 further regenerates the at least second layer based on the modified set of entities. By way of example, and not by limitation, the computer system 202 modifies the “mypath1” folder in the cache data of the “layer 5”, “layer 6”, and “layer 7” and further regenerates the “layer 5”, “layer 6”, and “layer 7” based on the determination of the presence of the first dependency relationship.

At 418, a dependency graph modification operation is performed. In the dependency graph modification operation, the computer system 202 modifies the dependency graph based on the modified first layer and the modified at least second layer. The modified dependency graph is indicative of a plurality of modified dependency relationships between the set of layers. In an embodiment of the disclosure, the computer system 202 modifies the cache data (the set of entities (the files, and the folders) and the set of hash-based identifiers) in the dependency graph based on the modified first layer and the modified at least second layer.

By way of example, and not by limitation, the computer system 202 modifies the contents of the folder “mypath1” and the checksum values in the cache data of the dependency graph 212D. The modified dependency graph 212D can be represented in Table 8 as given below:

TABLE 8
Modified Dependency Graph

| | | | Accessed | Checksum | | |
|---|---|---|---|---|---|---|
| | | | Files | Value | Checksum | |
| Node | | Corresponding | (Entities) | (Existing) | Value | Dependency |
| ID | Instructions | Layer | (Cache) | (Cache) | (New) | Relationship |
| 1 | FROM | Layer 1 | / | 436123723 | | No |
| | image:version | | /var/[ . . . ] | | | Dependency |
| | | | . . . | | | |
| | | | . . . | | | |
| | | | /usr/[ . . . ] | | | |
| 2 | RUN | Layer 2 | /usr/lib/ | 1234577 | | No |
| | apt install | | mypackage/[ . . . ] | | | Dependency |
| | mypackage | | /bin/mypackage | | | |
| | | | /var/lib/ | | | |
| | | | mypackage/[ . . . ] | | | |
| 3 | RUN | Layer 3 | /mypath1 | 51126674 | | No |
| | mkdir -p/ | | | | | Dependency |
| | mypath1 | | | | | |
| 4 | RUN | Layer 4 | /mypath2 | 23535345 | 4122849 | No |
| | mkdir -p/ | | | | | Dependency |
| | mypath2 | | | | | |
| 5 | COPY | Layer 5 | /mypath1/ | 78663234 | | Dependent |
| | mybinary1/ | | mybinary1 | | | on Layer 3 |
| | mypath1/ | | | | | |
| | mybinary1 | | | | | |
| 6 | COPY | Layer 6 | /mypath1/ | 64335245 | | Dependent |
| | mybinary2/ | | mybinary2 | | | on Layer 3 |
| | mypath1/ | | | | | |
| | mybinary2 | | | | | |
| 7 | RUN | Layer 7 | /mypath1/ | 55728631 | | Dependent |
| | /mypath1/ | | mybinary1 | | | on Layer 3 |
| | mybinary1 | | | | | and Layer 5 |

FIG. 4B is a diagram that illustrates second exemplary operations for modification of a dependency graph for modification of a container image of an application, in accordance with an embodiment of the disclosure. FIG. 4B is explained in conjunction with elements from FIG. 1, FIG. 2A, FIG. 2B, FIG. 3A, FIG. 3B, and FIG. 4A. With reference to FIG. 4B, there is shown the block diagram 400B that illustrates exemplary operations from 420 to 428, as described herein. The exemplary operations illustrated in the block diagram 400B start at 420 and are performed by any computing system, apparatus, or device, such as by the computer 102 of FIG. 1 or by the computer system 202 of FIG. 2A. Although illustrated with discrete blocks, the exemplary operations associated with one or more blocks of the block diagram 400B can be divided into additional blocks, combined into fewer blocks, or eliminated, depending on the implementation.

At 420, a third identifier generation operation is performed. In the third identifier generation operation, the computer system 202 generates a third hash-based identifier associated with the files and the folders of the at least second layer of the container image 212C based on the determination that the at least second layer is not dependent on the first layer. The computer system 202 generates the third hash-based identifier of the set of entities associated with the at least second layer based on the determination of the absence of the first dependency relationship as discussed above. The third hash-based identifier corresponds to one of a hash value, or a checksum value associated with the set of entities of the at least second layer.

In an embodiment of the disclosure, the computer system 202 similarly parses the input data 212B (the first set of instructions) to determine the set of entities (the files and the folders) and then generates (or calculates) the third hash-based identifier (the hash value or the checksum value) associated with the at least second layer. By way of example, and not by limitation, the computer system 202 generates the third hash-based identifier (the checksum value) associated with “layer 4” since “layer 4” is not dependent on the first layer “layer 3”. The generated checksum value of the entities of “layer 4” is “4122849”.

At 422, a fourth identifier extraction operation is performed. In the fourth identifier extraction operation, the computer system 202 extracts a fourth hash-based identifier from the cache data of the at least second layer in the dependency graph 212D. The fourth hash-based identifier corresponds to a historical hash value of the set of entities associated with the at least second layer calculated during the initial build of the at least second layer. In an embodiment, the computer system 202 calculates the historical hash value (the fourth hash-based) identifier similarly by using the hash function and stores it into the cache data. As discussed above, the dependency graph 212D includes the cache data associated with the set of layers of the container image 212C. The cache data further includes the set of entities associated with the set of layers and the set of hash-based identifiers associated with the set of entities. Specifically, the computer system 202 extracts the fourth hash-based identifier from the set of hash-based identifiers. By way of example, and not by limitation, the computer system 202 extracts the checksum of “layer 4” from the cache data as “23535345”.

At 424, it is determined whether the third hash-based identifier is equal to the fourth hash-based identifier. In an embodiment of the disclosure, the computer system 202 compares the third hash-based identifier with the fourth hash-based identifier. In an embodiment of the disclosure, the computer system 202 determines that the third hash-based identifier is equal (identical) to the fourth hash-based identifier based on the comparison. In an alternate embodiment of the disclosure, the computer system determines that the third hash-based identifier is not equal (different) to the fourth hash-based identifier based on the comparison. In an alternate embodiment, the computer system 202 further compares the commands in the first set of instructions with the instructions stored in the cache data to determine that the at least second layer is modified. In case the commands in the first set of instructions does not match the commands stored in the cache, the computer system 202 determines that the at least second layer is modified. In an alternate embodiment, the computer system 202 further parses the files and the folders to determine that the contents of the files and folders of at least second layer have been changed. In case the contents of the files and folders of the at least second layer have been changed, the computer system 202 determines that the at least second layer is modified.

Based on the determination that the third hash-based identifier is equal to the fourth hash-based identifier, the control of operations proceeds to 428 to modify the dependency graph only based on the modified first layer (since the at least second layer is not modified based on the dependency graph as well as based on the hash-based identifiers comparison). Based on the determination that the third hash-based identifier is not equal to the fourth hash-based identifier, the control of operations proceeds to 426 to modify the at least second layer and then the dependency graph 212D accordingly. Further, based on the determination that the commands in the first set of instructions and the instructions stored in the cache data does not match, the control of operations proceeds to 426, otherwise the control of operations proceeds to 428, as discussed above. Further, based on the determination that contents of all the files and folders of the at least second layer has not changed, the control of operations proceeds to 428 (as discussed above), otherwise the control of operations proceeds to 426.

By way of example, and not by limitation, the computer system 202 determines that the extracted checksum value “23535345” and the generated checksum value “4122849” are different, which indicates that the contents of the folder “mypath2” are modified. For example, a new sub-folder “mybinary2” is also added in the folder “mypath2”. Since the computer system 202 determines that the at least second layer is modified based on the comparison between hash-based identifiers and not by parsing the contents of the files and the folders, therefore, the processing time of the computer system 202 is lesser as compared to the traditional methods. Due to parsing of the entire files and the folders for the determination of the modification of the at least second layer, the processing time of the traditional methods were greater as compared to the computer system 202.

At 426, a second layer modification operation is performed. In the second layer modification operation, the computer system 202 modifies the at least second layer based on the determination that the third hash-based identifier of the set of entities associated with the at least second layer and the fourth hash-based identifier of the set of entities associated with the second layer are different or not equal (comparison).

Specifically, the computer system 202 modifies the set of entities associated with the at least second layer based on the modified entity and the fourth hash-based identifier (with the third hash-based identifier). The computer system 202 further updates the cache data of the at least second layer with the modified set of entities and the third hash-based identifier. The computer system 202 further regenerates the at least second layer based on the modified set of entities. By way of example, and not by limitation, the computer system 202 modifies the contents of the folder “mypath2” and adds the sub-folder “mybinary2” to the at least second layer. The computer system 202 further modifies the checksum value with the generated checksum in the cache data of “layer 4”.

At 428, a dependency graph modification operation is performed. In the dependency graph modification operation, the computer system 202 modifies the dependency graph 212D based on the modified first layer and the modified at least second layer. In an embodiment of the disclosure, the computer system 202 modifies the cache data (the set of entities (the files, and the folders) and the set of hash-based identifiers) in the dependency graph based on the modified first layer and the modified at least second layer. The computer system 202 obtains the modified set of entities and modifies the dependency graph 212D accordingly.

By way of example, and not by limitation, the computer system 202 modifies the contents of the folder “mypath2” and adds the subfolder “mybinary2”. The computer system 202 further modifies the extracted checksum with the generated checksum. The modified dependency graph can be represented in Table 9 below:

TABLE 9
Modified Dependency Graph

| | | | Accessed | Checksum | | |
|---|---|---|---|---|---|---|
| | | | Files | Value | Checksum | |
| Node | | Corresponding | (Entities) | (Existing) | Value | Dependency |
| ID | Instructions | Layer | (Cache) | (Cache) | (New) | Relationship |
| 1 | FROM | Layer 1 | / | 436123723 | | No |
| | image:version | | /var/[ . . . ] | | | Dependency |
| | | | . . . | | | |
| | | | . . . | | | |
| | | | /usr/[ . . . ] | | | |
| 2 | RUN | Layer 2 | /usr/lib/ | 1234577 | | No |
| | apt install | | mypackage/[ . . . ] | | | Dependency |
| | mypackage | | /bin/mypackage | | | |
| | | | /var/lib/ | | | |
| | | | mypackage/[ . . . ] | | | |
| 3 | RUN | Layer 3 | /mypath1 | 51126674 | | No |
| | mkdir -p/ | | | | | Dependency |
| | mypath1 | | | | | |
| 4 | RUN | Layer 4 | /mypath2/ | 4122849 | | No |
| | mkdir -p/ | | mybinary2 | | | Dependency |
| | mypath2/ | | | | | |
| | mybinary2 | | | | | |
| 5 | COPY | Layer 5 | /mypath1/ | 78663234 | | Dependent |
| | mybinary1/ | | mybinary1 | | | on Layer 3 |
| | mypath1/ | | | | | |
| | mybinary1 | | | | | |
| 6 | COPY | Layer 6 | /mypath1/ | 64335245 | 38725625 | Dependent |
| | mybinary2/ | | mybinary2 | | | on Layer 3 |
| | mypath1/ | | | | | |
| | mybinary2 | | | | | |
| 7 | RUN | Layer 7 | /mypath1/ | 55728631 | | Dependent |
| | /mypath1/ | | mybinary1 | | | on Layer 3 |
| | mybinary1 | | | | | and Layer 5 |

In an alternate embodiment of the disclosure, the computer system 202 modifies the dependency graph only using the modified first layer based on the determination that the at least second layer is not dependent on the first layer and the at least second layer is not modified. Since the second layer is not modified, the computer system modifies the dependency graph only according to the first layer.

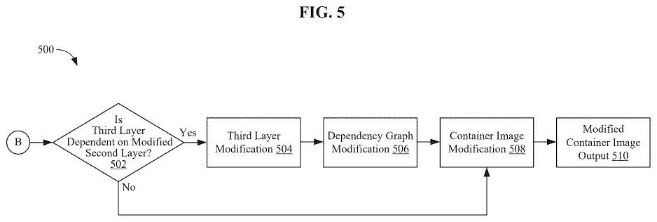

FIG. 5 is a diagram that illustrates exemplary operations for modification of a container image of an application using a dependency graph, in accordance with an embodiment of the disclosure. FIG. 5 is explained in conjunction with elements from FIG. 1, FIG. 2A, FIG. 2B, FIG. 3A, FIG. 3B, FIG. 4A and FIG. 4B. With reference to FIG. 5, there is shown the block diagram 500 that illustrates exemplary operations from 502 to 510, as described herein. The exemplary operations illustrated in the block diagram 500 start at 502 and are performed by any computing system, apparatus, or device, such as by the computer 102 of FIG. 1 or by the computer system 202 of FIG. 2A. Although illustrated with discrete blocks, the exemplary operations associated with one or more blocks of the block diagram 500 can be divided into additional blocks, combined into fewer blocks, or eliminated, depending on the implementation.

At 502, it is determined that at least a third layer of the set of layers of the container image 212C of the application 212A is dependent on the modified at least second layer of the container image 212C of the application 212A. In an embodiment of the disclosure, the computer system 202 determines one of a presence or an absence of a second dependency relationship between the at least third layer of the container image 212C and the modified at least second layer of the container image 212C. Dependency relationship between two layers of a specific container image exists when the two layers access common entities (common files or folders). Specifically, the computer system 202 determines the presence of the second dependency relationship (new dependency relationship) that occurred due to the modification of the at least second layer (the modified entities).

Based on the determination of the presence of the second dependency relationship, the control of operations proceeds to 504 to modify the at least third layer and the dependency graph accordingly and then to modify the container image based on the modified first layer, the modified at least second layer and the modified at least third layer. Based on the determination of the absence of the second dependency relationship, the control of operations proceeds to 508 to modify the container image only based on the modified first layer and the modified at least second layer (in case the at least second layer is modified).

By way of example, and not by limitation, the computer system 202 determines that the modified “layer 4” accesses common entity “binary 2” file with the “layer 6” after the modification that it was not accessing before. Therefore, the computer system 202 determines the presence of the second dependency relationship (new dependency relationship) that occurred due to the modification of “layer 4”.

At 504, a third layer modification operation is performed. In the third layer modification operation, the computer system 202 modifies the at least third layer of the container image 212C based on the determination of the presence of the second dependency relationship. Specifically, the computer system 202 modifies the set of entities associated with the at least third layer based on the modified entity and the hash-based identifier of the set of entities associated with the at least third layer. The computer system 202 further updates the cache data of the at least third layer with the modified set of entities. The computer system 202 further regenerates the at least third layer based on the modified set of entities. By way of example, and not by limitation, the computer system 202 modifies the checksum, the dependency, and the entities of “layer 6”.

At 506, a dependency graph modification operation is performed. In the dependency graph modification operation, the computer system 202 modifies the dependency graph based on the modified first layer, the modified at least second layer, and the modified at least third layer. In an embodiment of the disclosure, the computer system 202 adds the second dependency relationship in the dependency graph 212D between the modified at least second layer and the at least third layer that occurred due to the modification of the at least second layer.

By way of example, and not by limitation, the computer system 202 modifies the dependency relationship and the hash-based identifier of “layer 6” in dependency graph as given in Table 10 below:

TABLE 10
Modified Dependency Graph

| | | | Accessed | Checksum | | |
|---|---|---|---|---|---|---|
| | | | Files | Value | Checksum | |
| Node | | Corresponding | (Entities) | (Existing) | Value | Dependency |
| ID | Instructions | Layer | (Cache) | (Cache) | (New) | Relationship |
| 1 | FROM | Layer 1 | / | 436123723 | z | No |
| | image:version | | /var/[ . . . ] | | | Dependency |
| | | | . . . | | | |
| | | | . . . | | | |
| | | | /usr/[ . . . ] | | | |
| 2 | RUN | Layer 2 | /usr/lib/ | 1234577 | | No |
| | apt install | | mypackage/[ . . . ] | | | Dependency |
| | mypackage | | /bin/mypackage/ | | | |
| | | | var/lib/ | | | |
| | | | mypackage/[ . . . ] | | | |
| 3 | RUN | Layer 3 | /mypath1 | 51126674 | | No |
| | mkdir -p/ | | | | | Dependency |
| | mypath1 | | | | | |
| 4 | RUN | Layer 4 | /mypath2/ | 4122849 | | No |
| | mkdir -p/ | | mybinary2 | | | Dependency |
| | mypath2/ | | | | | |
| | mybinary2 | | | | | |
| 5 | COPY | Layer 5 | /mypath1/ | 78663234 | | Dependent |
| | mybinary1/ | | mybinary1 | | | on Layer 3 |
| | mypath1/ | | | | | |
| | mybinary1 | | | | | |
| 6 | COPY | Layer 6 | /mypath1/ | 38725625 | | Dependent |
| | mybinary2/ | | mybinary2 | | | on Layer 3 |
| | mypath1/ | | | | | and Layer 4 |
| | mybinary2 | | | | | |
| 7 | RUN | Layer 7 | /mypath1/ | 55728631 | | Dependent |
| | /mypath1/ | | mybinary1 | | | on Layer 3 |
| | mybinary1 | | | | | and Layer 5 |

At 508, a container image modification operation is performed. In the container image modification operation, the computer system 202 modifies the container image 212C of the application 212A based on the modified dependency graph. In an embodiment of the disclosure, the computer system 202 modifies the container image 212C of the application 212A based on the modified (regenerated) first layer, modified (regenerated) at least second layer, and the modified (regenerated) at least third layer.

In an alternate embodiment of the disclosure, the computer system 202 modifies the container image 212C of the application 212A using only the modified first layer and the modified at least second layer based on the determination of the absence of the second dependency relationship. In an alternate embodiment of the disclosure, the computer system modifies the container image 212C only based on the modified first layer based on a determination that no dependency relationships are present with the first layer. Since the computer system 202 regenerates only the dependent layers of the modified first layer of the container image 212C instead of regenerating each layer below the modified first layer, therefore, the processing time of the computer system 202 is lesser as compared to the traditional methods. Since the traditional methods had to regenerate each layer below the modified first layer, the processing time of the traditional methods were greater as compared to the computer system 202.

At 510, a modified container image output operation is performed. In the modified container image output operation, the computer system 202 outputs the modified container image of the application 212A. In an embodiment of the disclosure, the computer system 202 deploys the modified container image of the application 212A on the container development platform 206, and the modified container image can be hosted further on the various container orchestration platforms. In an alternate embodiment of the disclosure, the computer system 202 stores the modified container image into the server 208. In an alternate embodiment of the disclosure, the computer system 202 renders the message on the user device 210 “The container image of the application has been successfully generated”.

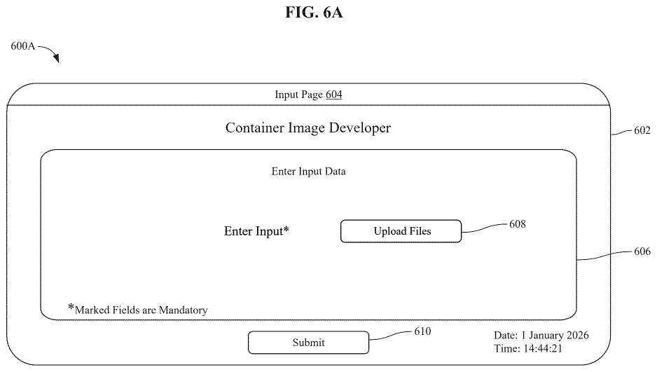

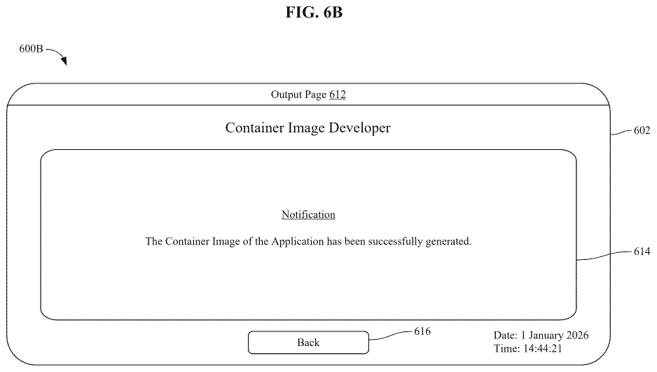

FIG. 6A is a diagram that illustrates an exemplary first user interface for modification of a container image of an application using a dependency graph, in accordance with an embodiment of the disclosure. FIG. 6A is explained in conjunction with elements from FIG. 1, FIG. 2A, FIG. 2B, FIG. 3A, FIG. 3B, FIG. 4A, FIG. 4B, and FIG. 5. With reference to FIG. 6A, there is shown an exemplary diagram 600A that includes a user device 602 and an input page 604. The input page 604 includes a first user interface (UI) element 606, a second UI element 608, and a third UI element 610. The user device 602 is an exemplary embodiment of the user device 210 of FIG. 2A.

With reference to FIG. 6A, the computer system 202 renders the input page 604 on the user interface (UI) of the user device 602. The input page 604 corresponds to a web page or online form that is designed to collect information from the user 214. In an embodiment of the disclosure, the input page 604 is used to gather relevant details from the user for the generation of the container image 212C of the application 212A.

As discussed above, the computer system 202 obtains the input data 212B (or the first set of instructions) for generating the set of layers of the container image 212C of the application. The first UI element 606 corresponds to a textbox and is labeled as “Enter input data”. The computer system 202 obtains the input data 212B (the first set of instructions) via the first UI element 606.

The second UI element 608 corresponds to a button labeled “Upload files”. Upon selecting the second UI element 608, the computer system 202 obtains the input data 212B (the first set of instructions) from the user device 602. The second UI element 608 is a mandatory input parameter for the generation of the container image 212C of the application 212A. The third UI element 610 corresponds to a button and is labeled as “Submit”. Upon selecting the third UI element 610, the computer system 202 receives the input data 212B and generates the modified container image of the application 212A. Details about the container image modification operation are provided, for example, in FIG. 2A and FIG. 5.

FIG. 6B is a diagram that illustrates an exemplary second user interface for modification of a container image of an application using a dependency graph, in accordance with an embodiment of the disclosure. FIG. 6B is explained in conjunction with elements from FIG. 1, FIG. 2A, FIG. 2B, FIG. 3A, FIG. 3B, FIG. 4A, FIG. 4B, FIG. 5, and FIG. 6A. With reference to FIG. 6B, there is shown an exemplary diagram 600B that includes the user device 602 and an output page 612. The output page 612 includes a fourth UI element 614 and a fifth UI element 616. The user device 602 is an exemplary embodiment of the user device 210 of FIG. 2A.

With reference to FIG. 6B, the computer system 202 renders the output page 612 on the display unit (or the user interface) of the user device 602 based on the generation of the modified container image of the application 212A. The computer system 202 renders the message on the output page 612 that indicates that the modified container image of the application is generated.

The fourth UI element 614 corresponds to a textbox that includes the message that indicates that the modified container image is generated. By way of example, and not by limitation, the computer system 202 renders the message “Notification: The Container Image of the Application has been successfully generated”. The fifth UI element 616 corresponds to a button and is labeled as “Back”. Upon selecting the fifth UI element 616, the computer system 202 renders the input page 604 on the user device 602.

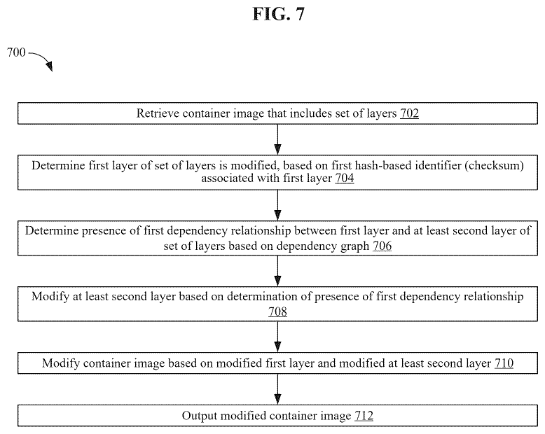

FIG. 7 is a diagram that illustrates a flowchart of a first exemplary method for modification of a container image of an application using a dependency graph, in accordance with an embodiment of the disclosure. FIG. 7 is explained in conjunction with elements from FIG. 1, FIG. 2A, FIG. 2B, FIG. 3A, FIG. 3B, FIG. 4A, FIG. 4B, FIG. 5, FIG. 6A, and FIG. 6B. With reference to FIG. 7, there is shown a flowchart 700. The operations of the exemplary method may be executed by any computing system, for example, by the computer 102 of FIG. 1 or the computer system 202 of FIG. 2A. The operations of the flowchart 700 may start at 702.

At 702, the container image 212C that includes the set of layers is retrieved. The container image 212C is associated with the application 212A. In an embodiment of the disclosure, the computer system 202 retrieves the container image 212C that includes the set of layers. The container image 212C is associated with the application 212A. Details about the container image retrieval operation are provided, for example, in FIG. 2A.

At 704, it is determined that the first layer of the set of layers is modified. The determination is based on the first hash-based identifier (the checksum) of the set of entities associated with the first layer. In an embodiment of the disclosure, the computer system 202 determines that the first layer of the set of layers is modified. The determination is based on the first hash-based identifier (the checksum) of the set of entities associated with the first layer. Specifically, the computer system 202 compares the first hash-based identifier (the generated checksum (that is generated based on the retrieved set of instructions)) associated with the first layer with the second hash-based identifier (stored in the cache data) associated with the first layer to determine that the first layer is modified. Details about the first layer modification determination operation are provided, for example, in FIG. 2A and FIG. 4A.

At 706, the presence of the first dependency relationship between the first layer and at least the second layer of the set of layers is determined based on the dependency graph 212D. The dependency graph is indicative of a plurality of dependency relationships between the set of layers. The plurality of dependency relationships is inclusive of the first dependency relationship. In an embodiment of the disclosure, the computer system 202 determines the one of the presence or the absence of the first dependency relationship between the first layer and at least a second layer of the set of layers based on the dependency graph 212D. The dependency graph is indicative of a plurality of dependency relationships between the set of layers. The plurality of dependency relationships is inclusive of the first dependency relationship. Details about the first dependency relationship determination operation and the dependency graph generation operation are provided, for example, in FIG. 2A, FIG. 3A and FIG. 4A.

At 708 the at least second layer is modified based on the determination of the presence of the first dependency relationship. In an embodiment of the disclosure, the computer system 202 modifies the at least second layer based on the determination of the presence of the first dependency relationship. Details about the second layer modification operation are provided, for example, in FIG. 2A, FIG. 4A, and FIG. 4B.

At 710, the container image 212C of the application 212A is modified based on the modified first layer and the modified at least second layer. In an embodiment of the disclosure, the computer system 202 modifies the container image 212C of the application 212A based on the modified first layer and the modified at least second layer. Details about the container image modification operation are provided, for example, in FIG. 2A and FIG. 5.

At 712, the modified container image is outputted. In an embodiment of the disclosure, the computer system 202 outputs the modified container image of the application 212A. Details about the container image output operation are provided, for example, in FIG. 2A and FIG. 5.

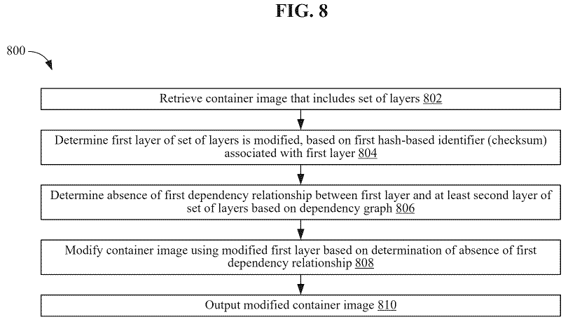

FIG. 8 is a diagram that illustrates a flowchart of a second exemplary method for modification of a container image of an application using a dependency graph, in accordance with an embodiment of the disclosure. FIG. 8 is explained in conjunction with elements from FIG. 1, FIG. 2A, FIG. 2B, FIG. 3A, FIG. 3B, FIG. 4A, FIG. 4B, FIG. 5, FIG. 6A, FIG. 6B, and FIG. 7. With reference to FIG. 8, there is shown a flowchart 800. The operations of the exemplary method may be executed by any computing system, for example, by the computer 102 of FIG. 1 or the computer system 202 of FIG. 2A. The operations of the flowchart 800 may start at 802.

At 802, the container image 212C that includes the set of layers is retrieved. The container image 212C is associated with the application 212A. In an embodiment of the disclosure, the computer system 202 retrieves the container image 212C that includes the set of layers. The container image 212C is associated with the application 212A. Details about the container image retrieval operation are provided, for example, in FIG. 2A.

At 804, it is determined that the first layer of the set of layers is modified. The determination is based on the first hash-based identifier (the checksum) associated with the first layer. In an embodiment of the disclosure, the computer system 202 determines that the first layer of the set of layers is modified. The determination is based on the first hash-based identifier (the checksum) of the set of entities associated with the first layer. Specifically, the computer system 202 compares the first hash-based identifier (the generated checksum (that is generated based on the retrieved set of instructions)) of the set of entities associated with the first layer with the second hash-based identifier (stored in the cache data) associated with the first layer to determine that the first layer is modified. Details about the first layer modification determination operation are provided, for example, in FIG. 2A and FIG. 4A.

At 806, the absence of the first dependency relationship between the first layer and at least the second layer of the set of layers is determined based on the dependency graph 212D. The dependency graph is indicative of a plurality of dependency relationships between the set of layers. The plurality of dependency relationships is exclusive of the first dependency relationship. In an embodiment of the disclosure, the computer system 202 determines the absence of the first dependency relationship between the first layer and at least a second layer of the set of layers based on the dependency graph 212D. The dependency graph is indicative of a plurality of dependency relationships between the set of layers. The plurality of dependency relationships is exclusive of the first dependency relationship. Details about the first dependency relationship determination operation and the dependency graph generation operation are provided, for example, in FIG. 2A, FIG. 3A and FIG. 4A.

At 808, the container image 212C of the application 212A is modified using the modified first layer based on the determination of the absence of the first dependency relationship. In an embodiment of the disclosure, the computer system 202 modifies the container image 212C of the application 212A using the modified first layer based on the determination of the absence of the first dependency relationship. Details about the container image modification operation are provided, for example, in FIG. 2A and FIG. 5.

At 810, the modified container image is outputted. In an embodiment of the disclosure, the computer system 202 outputs the modified container image of the application 212A. Details about the container image output operation are provided, for example, in FIG. 2A and FIG. 5.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
retrieving, by a computer, a container image comprising a set of layers, wherein the container image is associated with an application;
determining, by the computer, a first layer of the set of layers is modified, wherein the determination is based on a first hash-based identifier of a set of entities associated with the first layer;
determining, by the computer, a presence of a first dependency relationship between the first layer and at least a second layer of the set of layers based on a dependency graph, wherein the dependency graph is indicative of a plurality of dependency relationships between the set of layers, and wherein the plurality of dependency relationships is inclusive of the first dependency relationship;
modifying, by the computer, the at least second layer based on the determination of the presence of the first dependency relationship;
modifying, by the computer, the container image based on the modified first layer and the modified at least second layer; and
outputting, by the computer, the modified container image.

2. The computer-implemented method of claim 1, further comprising:
modifying, by the computer, the dependency graph based on the modified first layer and the modified at least second layer, wherein the modified dependency graph is indicative of a plurality of modified dependency relationships between the set of layers; and
outputting, by the computer, the modified dependency graph.

3. The computer-implemented method of claim 2, further comprising:
determining, by the computer, a presence of a second dependency relationship between the modified at least second layer and at least a third layer of the set of layers based on the modified dependency graph, wherein the plurality of modified dependency relationships is inclusive of the second dependency relationship;
modifying, by the computer, the at least third layer based on the determination of the presence of the second dependency relationship;
modifying, by the computer, the dependency graph based on the modified at least third layer; and
modifying, by the computer, the container image based on the modified dependency graph.

4. The computer-implemented method of claim 1, further comprising:
generating, by the computer, the first hash-based identifier of the set of entities associated with the first layer;
extracting, by the computer, a second hash-based identifier of the set of entities associated with the first layer from cache data associated with the set of layers;
comparing, by the computer, the first hash-based identifier associated with the first layer with the second hash-based identifier associated with the first layer; and
determining, by the computer, the first layer is modified, based on the comparison.

5. The computer-implemented method of claim 4, further comprising:
retrieving, by the computer, input data comprising a set of instructions associated with the application;
parsing, by the computer, the set of instructions; and
generating, by the computer, the first hash-based identifier of the set of entities based on the parsed set of instructions.

6. The computer-implemented method of claim 5, further comprising:
determining, by the computer, the presence of the first dependency relationship between the first layer and the at least second layer based on the cache data;
generating, by the computer, the dependency graph comprising a set of nodes mapped to the set of layers and the cache data associated with the set of layers, wherein the dependency graph is generated based on the determination of the presence of the first dependency relationship; and
generating, by the computer, the modified container image based on the generated dependency graph and the set of instructions.

7. The computer-implemented method of claim 6, further comprising:
determining, by the computer, the set of entities associated with each layer of the set of layers;
determining, by the computer, an entity of the set of entities is associated with each of the first layer and the at least second layer; and
determining, by the computer, the presence of the first dependency relationship based on the determination that the entity is associated with each of the first layer and the second layer.

8. The computer-implemented method of claim 7, wherein each entity of the set of entities corresponds to at least one of a folder or an accessed file.

9. The computer-implemented method of claim 8, wherein:
the cache data further comprises the set of entities and a set of hash-based identifiers associated with the set of entities,
each hash-based identifier of the set of hash-based identifiers corresponds to at least one of a hash value or a checksum value, and
the set of hash-based identifiers is exclusive of the first hash-based identifier and inclusive of the second hash-based identifier.

10. A computer system, comprising:
a processor set;
one or more computer-readable storage media; and
program instructions stored on the one or more computer-readable storage media, the program instructions executable by the processor set to cause the processor set to:
retrieve a container image that comprises a set of layers, wherein the container image is associated with an application;
determine a first layer of the set of layers is modified, wherein the determination is based on a first hash-based identifier of a set of entities associated with the first layer;
determine a presence of a first dependency relationship between the first layer and at least a second layer of the set of layers based on a dependency graph, wherein the dependency graph is indicative of a plurality of dependency relationships between the set of layers, and wherein the plurality of dependency relationships is inclusive of the first dependency relationship;
modify the at least second layer based on the determination of the presence of the first dependency relationship;
modify the container image based on the modified first layer and the modified at least second layer; and
output the modified container image.

11. The computer system of claim 10, wherein the program instructions further cause the processor set to:
modify the dependency graph based on the modified first layer and the modified at least second layer, wherein the modified dependency graph is indicative of a plurality of modified dependency relationships between the set of layers; and
output the modified dependency graph.

12. The computer system of claim 11, wherein the program instructions further cause the processor set to:
determine a presence of a second dependency relationship between the modified at least second layer and at least a third layer of the set of layers based on the modified dependency graph, wherein the plurality of modified dependency relationships is inclusive of the second dependency relationship;
modify the at least third layer based on the determination of the presence of the second dependency relationship;
modify the dependency graph based on the modified at least third layer; and
modify the container image based on the modified dependency graph.

13. The computer system of claim 10, wherein the program instructions further cause the processor set to:
generate the first hash-based identifier of the set of entities associated with the first layer;
extract a second hash-based identifier of the set of entities associated with the first layer from cache data associated with the set of layers;
compare the first hash-based identifier associated with the first layer with the second hash-based identifier associated with the first layer; and
determine the first layer is modified, based on the comparison.

14. The computer system of claim 13, wherein the program instructions further cause the processor set to:
retrieve input data that comprises a set of instructions associated with the application;
parse the set of instructions; and
generate the first hash-based identifier of the set of entities associated with the first layer based on the parsed set of instructions.

15. The computer system of claim 14, wherein the program instructions further cause the processor set to:
determine the presence of the first dependency relationship between the first layer and the at least second layer based on the cache data;
generate the dependency graph that comprises a set of nodes mapped to the set of layers and the cache data associated with the set of layers, wherein the dependency graph is generated based on the determination of the presence of the first dependency relationship; and
generate the modified container image based on the dependency graph and the set of instructions.

16. The computer system of claim 15, wherein the program instructions further cause the processor set to:
determine the set of entities associated with each layer of the set of layers, wherein each entity of the set of entities corresponds to at least one of a folder or an accessed file;
determine an entity of the set of entities is associated with each of the first layer and the at least second layer; and
determine the presence of the first dependency relationship based on the determination that the entity is associated with each of the first layer and the second layer.

17. The computer system of claim 16, wherein:
the cache data further comprises the set of entities and a set of hash-based identifiers associated with the set of entities,
each hash-based identifier of the set of hash-based identifiers corresponds to at least one of a hash value or a checksum value, and
the set of hash-based identifiers is exclusive of the first hash-based identifier and inclusive of the second hash-based identifier.

18. A computer-program product for modification of a container image, the computer-program product comprising:
one or more computer-readable storage media; and
program instructions stored on the one or more computer-readable storage media to perform operations comprising:
retrieving the container image that comprises a set of layers, wherein the container image is associated with an application;
determining a first layer of the set of layers is modified, wherein the determination is based on a first hash-based identifier of a set of entities associated with the first layer;
determining an absence of a first dependency relationship between the first layer and at least a second layer of the set of layers based on a dependency graph, wherein the dependency graph is indicative of a plurality of dependency relationships between the set of layers, and wherein the plurality of dependency relationships is exclusive of the first dependency relationship;
modifying the container image using the modified first layer based on the determination of the absence of the first dependency relationship; and
outputting the modified container image.

19. The computer-program product of claim 18, wherein the program instructions stored on the one or more computer-readable storage media perform the operations further comprising:
generating a second hash-based identifier of the set of entities associated with the at least second layer based on the determination of the absence of the first dependency relationship;
extracting a third hash-based identifier of the set of entities associated with the at least second layer from cache data associated with the set of layers;
comparing the second hash-based identifier associated with the at least second layer with the third hash-based identifier associated with the at least second layer; and
modifying the at least second layer based on the comparison.

20. The computer-program product of claim 18, wherein the program instructions stored on the one or more computer-readable storage media perform the operations further comprising:
retrieving input data that comprises a set of instructions associated with the application;
parsing the retrieved set of instructions;
generating the first hash-based identifier of the set of entities associated with the first layer based on the parsed set of instructions;
extracting a second hash-based identifier of the set of entities associated with the first layer from cache data associated with the set of layers;
comparing the first hash-based identifier associated with the first layer with the second hash-based identifier associated with the first layer; and
determining the first layer is modified, based on the comparison.
